(19) United States
(12) Patent Application Publication
(10) Pub. No.: US 2008/0071583 A1
(43) Pub. Date: Mar. 20, 2008

(54) Hierarchy of medical word headers

(76) Inventor: Anuthep Benja-Athon, New York, NY (US)

Correspondence Address: ANUTHEP BENJA-ATHON, 210 E 36th St., New York, NY, 10016, US

(21) Appl. No.: 11/986,657

(22) Filed: Nov. 26, 2007

Related U.S. Application Data
(63) Continuation-in-part of application No. 11/114,763, filed on Apr. 27, 2005.
(63) Continuation-in-part of application No. 11/196,823, filed on Aug. 4, 2005.
(63) Continuation-in-part of application No. 11/973,866, filed on Oct. 11, 2007.
(63) Continuation-in-part of application No. 11/543,895, filed on Oct. 6, 2006.
(63) Continuation-in-part of application No. 11/510,820, filed on Aug. 28, 2006.
(63) Continuation-in-part of application No. 11/477,121, filed on Jun. 29, 2006.
(63) Continuation-in-part of application No. 11/255,229, filed on Oct. 21, 2005.
(63) Continuation-in-part of application No. 11/022,410, filed on Dec. 27, 2004, now abandoned.
(63) Continuation-in-part of application No. 11/074,236, filed on Mar. 7, 2005.

(51) Int. Cl. G06Q 50/00; G06F 17/30; G06F 17/40

(52) U.S. Cl. 705/3

(57) ABSTRACT

A system of words and terms and a hierarchy of words, terms and phrases for effecting the insertions or placements of second health and health-care data and information into the computer database or databases from which the data and information are retrieved and incorporated with first health and health-care data and information to generate resultant health and health-care data and information viewable, comprehensible and use by patients and physicians.

This application is a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/543,895 entitled Vital elements of speech recognition filed Oct. 6, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/255,229 entitled the Best Method of Computerized Transcriptions filed Oct. 21, 2005, and a continuation-in-part of Ser. No. 11/022,410 entitled Physicians' way of information productions filed Dec. 27, 2004, a continuation-in-part of Ser. No. 11/074,236 entitled A system of management of health-care resources filed Mar. 7, 2005 which are pending.

### FIELD OF INVENTION

Words and terms and an order of words and terms for compiling patients' and physicians' health and health-care data and information.

### BACKGROUND OF THE INVENTION

The concepts of and means for generating second health and health-care data and information on patients by physicians and the incorporations of said data and information into a larger first health and health-care data and information generate by patients and physicians are taught in said pending patent applications of the present applicants.

However, the means for effecting said incorporations of said second with first data and information to produce the resultant health and health-care data and information on patients and physicians was heretofore not described.

Therefore, the present invention provides a means for effecting the insertions or placements of said second data and information into database or databases of computer programs and software infra and said incorporations of said second data and information with said first data and information to produce the resultant health and health-care data and information on patients and physicians which are viewable on the viewing screens of electronic devices and comprehensible and use by patients and physicians.

The immense benefits for billions of people and humanity are described in said pending patent applications.

### SUMMARY OF THE INVENTION

There was no prior art with one exception infra teaching the combinations of second health and health-care data and information derive from physicians in the form of digital voice data and information on health and health-care with the larger first health and health-care data and information generate by keyboarding by patients and physicians. Although said pending patent applications of the present applicants taught said combinations, they did not describe the means for effecting said incorporations of said second with said first data and information to produce the resultant health and health-care data and information on patients and physicians.

The present invention is a method and system of using a group of medical words and terms and a hierarchy of words and terms for effecting the insertions or placements of second health and health-care data and information on patients generate by and viewable on the viewing screens of electronic devices by physicians into the computer database or databases from which said data and information are incorporated with first health and health-care data and information generate by said patients and physicians to produce resultant health and health-care data and information viewable on viewing screens and comprehensible and use by patients and physicians wherein said first health and health-care data and information are generated and stored in and retrieved from computer database or databases.

### DESCRIPTION OF THE PREFERRED EMBODIMENTS

One of the preferred embodiments of the present invention is the second health and health-care data and information on patients generate by physicians comprising a group of words and terms and a hierarchy or an order of words, terms, phrases, headings and/or headers. Specifically, a hierarchy of certain selected words, terms, phrases serve as headings and/or headers for inserting or placing health and health-care data and information on patients into database or databases.

As taught in said pending Ser. No. 11/196,823, a tag means for labeling each electronic package or file of said health and health-care data and information is used to identify, guide or route each electronic package or file of health and health-care data and information in and throughout the network or networks of electronic devices such as, but not limited to, digital voice recorders, cellular, mobile and/or smart phones, computers and servers and the like.

Said tag means is such as, but not limited to, individual physicians' medical or surgical specialties or practices, physicians' names and/or physicians' unique identification in alphabets, alphanumerics, digits or numerics, and/or patients' names and/or patients' identification in alphabets, alphanumerics, digits or numerics of each health and health-care data and information or any combination thereof. As taught in the pending patent application of the current patent applicants, each said specialties, names and/or identifications or any combination thereof tag or label and identify each file of health and health-care data and information of and relate to appropriate patients and physicians and their medical or surgical specialties or practices.

The words, terms, phrases and the hierarchy or order of these words, terms, phrases, headings and/or headers are such as, but not limited to, Evaluation, Chief Complaints, Review of Systems, Physical Examination, Diagnosis, Differential Diagnosis, Laboratory, Assessment Plan, Treatment, Medications, Surgery, Recommendation, Follow-Up, Date of Service and/or the synonyms and equivalences and the like of said words, terms and phrases used and use by physicians such as, but not limited to, Complaint, Neurological Complaint, System Review, Review of Organs, Examination, Finding, Test, Drug, Procedure, etc., in singular and/or plural.

Furthermore, there are many preferred embodiments of the present invention as the applications of synonyms of said words, terms and phrases and also derivatives of said hierarchy or order by rearranging or reordering said words, terms, phrases, headings and/or headers order to form varying hierarchies or arrangements of words, terms, phrases, headings and/or headers such as, but not limited to, Date of Service, Evaluation, Chief Complaints, Physical Examination, Review of System, Differential Diagnosis, Laboratory, Diagnosis, Assessment Plan, Treatment, Medications, Surgery, Recommendation, Follow-Up, Date of Service and the synonyms and equivalences and the like of said words, terms and phrases which are headings or headers.

The use of punctuation such as, but not limited to, commas and full-stops used for writing said sentences in the present context are not used or may not be included in the formation of said hierarchy, order, hierarchies and orders of said words, terms, phrases, headings or headers to achieve the goals and objectives of the present invention. Thus, as taught in the pending patent applications of the present patent applicants, physicians generate second health and health-care data and information on patients based on one of the preferred embodiments of the present invention as follows:

Tag Means Evaluation * Chief Complaints * Review of Systems * Physical Examination * Diagnosis * Differential Diagnosis * Laboratory * Assessment Plan * Treatment * Medications * Surgery * Recommendation * Follow-Up * wherein the “*” supra and infra representing words, terms, phrases and/or sentences comprising second health and health-care data and information on patients generate by physicians and are coupled, linked or bound in productions of said second health and health-care data and information on patients by physicians to said headings or headers as described supra in the formats such as, but not limited to, that are shown supra and infra.

As an example of infinite possibilities of hierarchies of words, terms, phrases and health and health-care data and information:

Dr. John Dole Patient Jane M. Dole Evaluation Consultation Chief Complaints Fever Malaise Review of Systems Hematuria duration 4 days Nausea vomit 6 days Physical Examination Swollen lymph nodes in the armpits Diagnosis Streptococcal infection Differential Diagnosis Renal failure Glomerulonephritis Laboratory CBC SMA12 Renal CTScan Assessment Plan Streptococcal Infection Kidney failure Treatment See below Medications Oral prednisone 2 weeks Surgery None Recommendation Reduce protein intake Rest Follow-Up Return in one week

To further facilitate comprehension, another one of the preferred embodiments of the present invention is illustrated infra as said couples of words, terms and phrases comprising said second health and health-care data and information on patients as described earlier pending patent applications of the current patent applicants as follows:

Tag Means

Evaluation *

Chief Complaints *

Review of Systems *

Physical Examination *

Diagnosis *

Differential Diagnosis *

Laboratory *

Assessment Plan *

Treatment *

Medications *

Surgery *

Recommendation *

Follow-Up *

As an example of infinite possibilities of hierarchies of words, terms, phrases and health and health-care data and information:

Dr. John Dole

Patient Jane M. Dole

Evaluation Consultation

Chief Complaints Fever Malaise

Review of Systems Hematuria duration 4 days Nausea vomit 6 days

Physical Examination Swollen lymph nodes in the armpits

Diagnosis Streptococcal infection

Differential Diagnosis Renal failure Glomerulonephritis

Laboratory CBC SMA12 Renal CTScan

Assessment Plan Streptococcal Infection Kidney failure

Treatment See below

Medications Oral prednisone 10 days

Surgery None

Recommendation Reduce protein intake Rest

Follow-Up Return in one week

The headings or headers in one of the preferred hierarchies infra serve as prefixes, tags or labels for the second health and health-care data and information relate or couple to said word or words prefixes as taught in said pending patent applications of the present patent applicants.

Dr 1 Patient 600010 Jack Smith Evaluation Consultation Chief Complaints Fever Malaise Review of Systems Hematuria duration 4 days Nausea vomit 6 days Physical Examination Swollen lymph nodes in the armpits Diagnosis Streptococcal infection Differential Diagnosis Renal failure Glomerulonephritis Laboratory CBC SMA12 Renal CTScan Assessment Plan Streptococcal Infection Kidney failure Treatment See below Medications Oral prednisone 2 weeks Surgery None Recommendation Reduce protein intake Rest Follow-Up Return in one week

In other words, using these prefixes, tags or labels, the computer programs infra cause the insertions or placements of the health and health-care data and information coupled to individual headings or headers into said database or databases of computer programs and/or software such as, but not limited to, Microsoft SQL and the like. As written, many types of database means for holding, storing and retrieving said data and information can be used to achieve the goals and objectives of the present invention.

Similarly, existing in said computer programs and/or software are said first health and health-care data comprising said headings, headers, prefixes, tags and labels, their synonyms, equivalences and the like viewable on the viewing screens of electronic devices according to the spirit and scope of the claims infra to achieve the objectives and goals of the present invention.

Said second and first health and health-care data and information are generated or created by patients and physicians and are inserted by computer programs and/or software and stored in computer databases such as, but not limited to, databases in Microsoft SQL and related infra and the like.

Consequent to the incorporations of said data and information using computer programs, software mentioned herein and the like, the products of said incorporations are stored in and retrieved from databases to be displayed on the viewing screens and comprehensible and use by patients and physicians.

Although it has been described in pending earlier patent applications, said data and information are words, terms, phrases, synonyms, codes, numbers, sentences, etc. used and use by physicians in all—approximately 80—medical and surgical specialties and practices to describe and document data and information on diseases, illnesses, disorders, health and health-care of patients.

Said programs, layouts and formats are used for the insertions of second health and health-care data and information into first health and health-care data generated by patients and physicians by the computers/servers system using and operating the computer programs produced for the present invention and commercially available software (plural), programs and computer languages such as, but not limited to, those made and sold by Microsoft Corporation such as, but not limited to, Microsoft SQL, Visual Studio and Net and their databases and derivatives, other computer corporations' and companies' programs and languages, databases and their derivatives which are commonly and routinely used or use by computer engineers and programmers such as, but not limited to, PHP, PERL, C languages, etc.

It is understood that—by laws and ethics—each electronic package or file of second and resultant health and health-care data and information on a patient belongs or relates to said patient and is generated by a physician so that said patient and physician and authorized physicians are able to view on the viewing screens of electronic devices and use said data and information. Similarly, each electronic file of first health and health-care data and information on a patient and individual products or results of said incorporations of said second health and health-care data and information with said first health and health-care data and information belong or relate to said patient and are viewable on viewing screens and used by said patient, physician and authorized physicians.

Although various preferred embodiments of the present invention have been described, it will be appreciated by those skilled in the art that adaptations and variations may be made without departing from the spirit and the scope of the claims of the present invention.

1. A method of using words and terms and a hierarchy of words and terms for effecting the insertions or placements of second health and health-care data and information on patients generate by physicians into computer database or databases and for retrieving said data and information from said database or databases for incorporating with first health and health-care data and information generate by patients and physicians for effecting the displays of said health and health-care data and information, wherein said first health and health-care data and information are also inserted or placed in computer database or databases and wherein the resultant products of said integrations of said data and information are retrieved and viewed on the viewing screens, comprehensible and use by said patients and physicians comprises:
a process of using tag means for labeling second health and health-care data and information;
a process of using a group of medical words;
a process of using hierarchy of couples of words;
a process of using a hierarchy of couples of words and terms;
a process of using a hierarchy couples of words and phrases;
a process of using a hierarchy of couples of words, terms and phrases;
a process of relating words, terms and phrases in said hierarchy, health and health-care data and information;
a process of using a means for using said words and terms for incorporating health and health-care data and information;
a process of using said hierarchy of words and terms for effecting the insertions or placements of second health and health-care data and information on patients into computer database or databases;
a process of retrieving second data and information in database or databases for incorporating with first health and health-care data and information;
a process of incorporating said data and information; and
a process of displaying the resultant products of said integrations of said data and information on the viewing screens.

2. A method of using words and terms and a word and term hierarchy means for effecting the insertions or placements of second health and health-care data and information on patients generate by physicians into computer database or databases and for effecting the incorporations of said second health and health-care data and information with first health and health-care data and information generate by patients and physicians and store in and retrieve from computer database or databases for effecting the displays of said health and health-care data and information and the resultant products of said incorporations of said data and information on the viewing screens which are comprehensible and use by said patients and physicians comprises:
a process of using tag means for labeling second health and health-care data and information;
a process of using a group of medical words;
a process of using hierarchy of couples of words;
a process of using a hierarchy of couples of words and terms;
a process of using a hierarchy couples of words and phrases;
a process of using a hierarchy of couples of words, terms and phrases;
a process of relating words, terms and phrases in said hierarchy, health and health-care data and information;
a process of using a means for using said words and terms for incorporating health and health-care data and information;
a process of using said hierarchy of words and terms for effecting the insertions or placements of second health and health-care data and information on patients into computer database or databases;
a process of retrieving second data and information in database or databases for incorporating with first health and health-care data and information;
a process of incorporating said data and information; and
a process of displaying the resultant products of said integrations of said data and information on the viewing screens.

3. The method according to claim 2 wherein said means for effecting the insertions of second health and health-care data and information on patients generate by physicians into computer database or databases comprises a hierarchy of words, terms and phrases use and generate by physicians.

4. The method according to claim 2 wherein said means for effecting the insertions of second health and health-care data and information on patients generate by physicians into computer database or databases comprises a hierarchy of words, terms and phrases and synonyms of words, terms and phrases use and generate by physicians.

5. A system of hierarchy of words and terms for effecting the insertions or placements of second health and health-care data and information on patients generate by and viewable on the viewing screens of electronic devices by physicians into the computer database or databases from which said data and information are incorporated with first health and health-care data and information generate by said patients and physicians to produce resultant health and health-care data and information viewable on viewing screens and comprehensible and use by patients and physicians wherein said first health and health-care data and information are generated and stored in and retrieved from computer database or databases and wherein said health and health-care data and information are related to said words and terms in said hierarchy comprises:
a tag means for labeling second health and health-care data and information;
a hierarchy of words and terms for effecting the insertions or placements of second health and health-care data and information on patients into computer database or databases;
a group of medical words;
a hierarchy of couples of words;
a hierarchy of couples of words and terms;
a hierarchy couples of words and phrases;
a hierarchy of couples of words, terms and phrases;
relationships of words, terms, phrases in said hierarchy and health and health-care data and information; and
a means for using said words and terms for placing health and health-care data and information into database or databases;
a means for using said words and terms for incorporating health and health-care data and information.

6. The system of hierarchy of words and terms for effecting the insertions or placements of second health and health-care data and information according to claim 5 wherein said means for using said words and terms for placing health and health-care data and information into database or databases comprises computer programs comprising code means for placing health and health-care data and information generate by physicians in data and information files into database files.

7. The system of hierarchy of words and terms for effecting the insertions or placements of second health and health-care data and information according to claim 5 wherein said means for using said words and terms for incorporating health and health-care data and information comprises computer program-code means for effecting the incorporations or merges of health and health-care data and information.
